(19) United States
(12) Patent Application Publication
(10) Pub. No.: US 2022/0315435 A1
(43) Pub. Date: Oct. 6, 2022

(54) POSITIVE ACTIVE MATERIAL, POSITIVE ELECTRODE, NONAQUEOUS ELECTROLYTE ENERGY STORAGE DEVICE, METHOD OF PRODUCING POSITIVE ACTIVE MATERIAL, METHOD OF PRODUCING POSITIVE ELECTRODE, AND METHOD OF PRODUCING NONAQUEOUS ELECTROLYTE ENERGY STORAGE DEVICE

(71) Applicant: GS Yuasa International Ltd., Kyoto-shi, Kyoto (JP)

(72) Inventor: Yusuke MIZUNO, Kyoto (JP)

(21) Appl. No.: 17/634,169

(22) PCT Filed: Dec. 13, 2019
(86) PCT No.: PCT/JP2019/048977

§ 371 Date: Feb. 9, 2022

(30) Foreign Application Priority Data
Aug. 20, 2019 (JP) 2019-150616

(51) Int. Cl. C01D 15/02; H01M 10/0525; C01G 15/00; C01G 17/00; C01G 51/04; C01B 33/24; C01F 7/043

(52) U.S. Cl. CPC C01D 15/02; H01M 10/0525; C01G 15/00; C01G 17/00; C01G 51/04; C01B 33/24; C01F 7/043; C01P 2002/76; C01P 2002/74; C01P 2006/40

(57) ABSTRACT

One aspect of the present invention is a positive active material that contains an oxide containing lithium, a transition metal element and a typical element, and having an antifluorite crystal structure, in which the transition metal element is cobalt, iron, copper, manganese, nickel, chromium, or a combination thereof, the typical element is a group 13 element, a group 14 element, phosphorus, antimony, bismuth, tellurium or a combination thereof, and a molar ratio of a content of the typical element to a total content of the transition metal element and the typical element in the oxide is more than 0.05 and 0.5 or less.

### TECHNICAL FIELD

The present invention relates to a positive active material, a positive electrode, a nonaqueous electrolyte energy storage device, a method of producing a positive active material, a method of producing a positive electrode, and a method of producing a nonaqueous electrolyte energy storage device.

### BACKGROUND ART

Nonaqueous electrolyte secondary batteries typified by lithium ion secondary batteries are widely used for electronic devices such as personal computers and communication terminals, automobiles and the like because these secondary batteries have a high energy density. The nonaqueous electrolyte secondary battery generally has a pair of electrodes, electrically separated from each other with a separator, and a nonaqueous electrolyte interposed between the electrodes, and the secondary battery is configured to allow ions to be transferred between both the electrodes for charge-discharge. Capacitors such as a lithium ion capacitor and an electric double layer capacitor are also widely used as nonaqueous electrolyte energy storage devices other than the nonaqueous electrolyte secondary battery.

Various active materials are used for the positive electrode and the negative electrode of the nonaqueous electrolyte energy storage device, and various composite oxides are widely used as the positive active material. As one of the positive active materials, a transition metal solid solution metal oxide in which a transition metal element such as Co or Fe is made into a solid solution in Li₂O has been developed (see Patent Documents 1 and 2).

### PRIOR ART DOCUMENTS

### Patent Documents

Patent Document 1: JP-A-2015-107890
Patent Document 2: JP-A-2015-32515

### SUMMARY OF THE INVENTION

### Problems to be Solved by the Invention

In the above-mentioned conventional positive active material in which a transition metal element is made into a solid solution in Li₂O, an initial discharge capacity is not large. In addition, in the conventional positive active material in which a transition metal element is made into a solid solution in Li₂O, charge-discharge cycle performance is also insufficient. That is, in the case of the conventional positive active material in which a transition metal element is made into a solid solution in Li₂O, the discharge capacity and the like greatly decreases with a charge-discharge cycle, so that it is difficult to use the positive active material by repeating charge and discharge many times with a sufficient amount of electricity.

The present invention has been made based on the above circumstances, and it is an object of the present invention to provide a positive active material having a large discharge capacity at an initial stage and after a charge-discharge cycle and capable of being charged and discharged many times with a sufficient amount of electricity, a positive electrode and a nonaqueous electrolyte energy storage device having such a positive active material, a method of producing the positive active material, a method of producing the positive electrode, and a method of producing the nonaqueous electrolyte energy storage device.

### Means for Solving the Problems

One aspect of the present invention is a positive active material that contains an oxide containing lithium, a transition metal element and a typical element, and having an antifluorite crystal structure, in which the transition metal element is cobalt, iron, copper, manganese, nickel, chromium, or a combination thereof, the typical element is a group 13 element, a group 14 element, phosphorus, antimony, bismuth, tellurium or a combination thereof, and a molar ratio of a content of the typical element to a total content of the transition metal element and the typical element in the oxide is more than 0.05 and 0.5 or less.

Another aspect of the present invention is a positive electrode having the positive active material.

Another aspect of the present invention is a nonaqueous electrolyte energy storage device including the positive electrode.

Another aspect of the present invention is a method of producing a positive active material, including treating a material containing a transition metal element and a typical element by a mechanochemical method, in which the material contains a lithium transition metal oxide including the transition metal element and a compound including the typical element, or contains a lithium transition metal oxide including the transition metal element and the typical element, the transition metal element is cobalt, iron, copper, manganese, nickel, chromium, or a combination thereof, the typical element is a group 13 element, a group 14 element, phosphorus, antimony, bismuth, tellurium or a combination thereof, and a molar ratio of a content of the typical element to a total content of the transition metal element and the typical element in the material is more than 0.05 and 0.5 or less.

Another aspect of the present invention is a method of producing a positive electrode, including preparing the positive electrode using the positive active material or the positive active material obtained by the method of producing the positive active material.

Another aspect of the present invention is a method of producing a nonaqueous electrolyte energy storage device including the method of producing a positive electrode.

### Advantages of the Invention

According to one aspect of the present invention, it is possible to provide a positive active material having a large discharge capacity at an initial stage and after a charge-discharge cycle and capable of being charged and discharged many times with a sufficient amount of electricity, a positive electrode and a nonaqueous electrolyte energy storage device having such a positive active material, a method of producing the positive active material, a method of producing the positive electrode, and a method of producing the nonaqueous electrolyte energy storage device.

### BRIEF DESCRIPTION OF THE DRAWINGS

FIG. 1 is an external perspective view showing a nonaqueous electrolyte energy storage device according to one embodiment of the present invention.

FIG. 2 is a schematic diagram showing an energy storage apparatus including a plurality of the nonaqueous electrolyte energy storage devices according to one embodiment of the present invention.

FIG. 3 is an X-ray diffraction diagram of each oxide obtained in Synthesis Examples 1 and 2 and Reference Synthesis Examples 1 to 3.

FIG. 4 is an X-ray diffraction diagram of each positive active material (oxide) obtained in Examples 1 to 4 and Comparative Example 1.

FIG. 5 is an X-ray diffraction diagram of each positive active material (oxide) obtained in Examples 5 to 7.

### MODE FOR CARRYING OUT THE INVENTION

First, outlines of a positive active material, a positive electrode, a nonaqueous electrolyte energy storage device, a method of producing a positive active material, a method of producing a positive electrode, and a method of producing a nonaqueous electrolyte energy storage device disclosed in the present specification will be described.

The positive active material according to one aspect of the present invention is a positive active material that contains an oxide containing lithium, a transition metal element M and a typical element, and having an antifluorite crystal structure, in which the transition metal element M is cobalt, iron, copper, manganese, nickel, chromium, or a combination thereof, the typical element A is a group 13 element, a group 14 element, phosphorus, antimony, bismuth, tellurium or a combination thereof, and a molar ratio (A/(M+A)) of a content of the typical element A to a total content of the transition metal element M and the typical element A in the oxide is more than 0.05 and 0.5 or less.

In the positive active material, a discharge capacity is large at an initial stage and after a charge-discharge cycle, and the positive active material can be charged and discharged many times with a sufficient amount of electricity. Although the reason for this is not clear, the following reason is presumed. The oxide contained in the positive active material is typically a composite oxide in which the transition metal element M and the typical element A are made into a solid solution in a predetermined ratio with respect to Li₂O having an antifluorite crystal structure. The typical element A is a p-block element that can be a cation and can be made into a solid solution in Li₂O. In the above oxide, an oxygen atom O is presumed to form an sp hybrid orbital of Asp-O2p in addition to the M3d-O2p hybrid orbital. Since a bond due to the sp hybrid orbital of Asp-O2p is very strong, it is considered that the larger the content of the typical element A in the oxide, the better structural stability of the oxide. On the other hand, it is considered that as the content of the typical element A in the oxide increases, the transition metal element M (that is, total amount of d-electrons) decreases, so that electron conductivity decreases. Thus, a content ratio of the typical element A and the transition metal element M that are made into a solid solution in Li₂O is adjusted, and the molar ratio (A/(M+A)) of the content of the typical element A to the total content of the transition metal element M and the typical element A is more than 0.05 and 0.5 or less, so that the structural stability and the electron conductivity can be balanced. Thus, it is presumed that in the positive active material, the discharge capacity is large, the charge-discharge cycle performance is improved, and the positive active material can be charged and discharged many times with a sufficient amount of electricity.

In the positive active material according to one aspect of the present invention, a lattice constant a of the oxide is preferably 0.4590 nm or more and 0.4630 nm or less. When the lattice constant a is in the above range, it is presumed that a more suitable content of the typical element A is made into a solid solution, the discharge capacity becomes larger, and charge and discharge can be performed more times.

In the present specification, the lattice constant a of the oxide refers to that obtained by X-ray diffraction measurement and automatic analysis processing carried out by the following method. Specifically, the X-ray diffraction measurement of the oxide is performed by powder X-ray diffraction measurement using an X-diffraction device (“MiniFlex II” from Rigaku Corporation) under conditions such that a CuKα ray is used as a radiation source, a tube voltage is 30 kV, and a tube current is 15 mA. At this time, the diffracted X-ray passes through a Kβ filter having a thickness of 30 μm and is detected by a high-speed one-dimensional detector (D/teX Ultra 2). A sampling width is 0.02°, a scanning speed is 5°/min, a divergence slit width is 0.625°, a light receiving slit width is 13 mm (OPEN), and a scattering slit width is 8 mm. The obtained X-ray diffraction pattern is subjected to automatic analysis processing using PDXL (analysis software, manufactured by Rigaku Corporation). First, measurement data is load into PDXL. Next, in order to match calculated data with the measurement data, “optimization” is performed so that error data is 1000 cps or less. In a task pane of the “optimization”, “precise background” and “automatic” are selected. When the optimization is completed, data of “ICDD PDF 00-012-0254” is extracted from a column of “read card information” of a flow bar, the column is moved to a column of “crystal phase candidate”, and “confirmation” is determined. Next, “lattice constant refinement” of the flow bar is selected, “lithia” is selected as a phase to be analyzed, and a column of “No” at 33° and 56° is checked. “No correction” in “angle correction” is selected to perform “refinement”, so that the value of the lattice constant is output.

In the positive active material according to one aspect of the present invention, in an X-ray diffraction diagram using the CuKα ray of the oxide, a full width at half maximum of a diffraction peak near a diffraction angle 2θ=33° is preferably 0.3° or more. According to such a configuration, it is possible to highly reliably provide a positive active material having a large discharge capacity at the initial stage and after the charge-discharge cycle and capable of being charged and discharged many times. In the present specification, the diffraction peak near the diffraction angle 2θ=33° refers to a peak having the strongest diffraction intensity in the range of the diffraction angle 2θ of 30° to 35°.

The positive electrode according to one aspect of the present invention is a positive electrode having the positive active material. Since the positive electrode has the positive active material, the discharge capacity at the initial stage and after the charge-discharge cycle of the nonaqueous electrolyte energy storage device including the positive electrode can be increased, and charge and discharge can be performed many times with a sufficient amount of electricity.

The positive electrode according to one aspect of the present invention includes a positive active material layer containing the positive active material, and the content of the oxide in the positive active material layer is preferably more than 10% by mass. By increasing the content ratio of the oxide in the positive active material layer in this way, the discharge capacity at the initial stage and after the charge-discharge cycle of the nonaqueous electrolyte energy storage device including the positive electrode can be increased, and charge and discharge can be performed more times.

The nonaqueous electrolyte energy storage device according to one aspect of the present invention is a nonaqueous electrolyte energy storage device including the positive electrode (hereinafter, may be simply referred to as “energy storage device”). In the energy storage device, the discharge capacity is large at the initial stage and after the charge-discharge cycle, and the energy storage device can be charged and discharged many times with a sufficient amount of electricity.

The method of producing a positive active material according to one aspect of the present invention includes treating a material containing a transition metal element M and a typical element A by a mechanochemical method, in which the material contains a lithium transition metal oxide including the transition metal element M and a compound including the typical element A, or contains a lithium transition metal oxide including the transition metal element M and the typical element A, the transition metal element M is cobalt, iron, copper, manganese, nickel, chromium, or a combination thereof, the typical element A is a group 13 element, a group 14 element, phosphorus, antimony, bismuth, tellurium or a combination thereof, and a molar ratio of a content of the typical element to a total content of the transition metal element M and the typical element Ain the material is more than 0.05 and 0.5 or less.

According to the production method, it is possible to produce a positive active material having a large discharge capacity at the initial stage and after the charge-discharge cycle and capable of being charged and discharged many times with a sufficient amount of electricity.

The method of producing a positive electrode according to one aspect of the present invention is a method of producing a positive electrode, including preparing the positive electrode using the positive active material or the positive active material obtained by the method of producing the positive active material.

According to the production method, it is possible to produce a positive electrode having a large discharge capacity at the initial stage and after the charge-discharge cycle and capable of being charged and discharged many times with a sufficient amount of electricity.

In the method of producing a positive electrode, preparing the positive electrode preferably includes mechanically milling a mixture containing the positive active material or the positive active material obtained by the method of producing the positive active material, and a conductive agent.

By performing such processing, it is possible to produce a positive electrode having a large discharge capacity at the initial stage and after the charge-discharge cycle and capable of being charged and discharged more times. Although the reason why such an effect occurs is not clear, the following reason is presumed. In a general mixing method using a mortar or the like, a mixture in which the positive active material contacts the conductive agent only with bulk surfaces is obtained. On the other hand, it is considered that when the mechanical milling treatment is performed, since pulverization and agglomeration of particles are repeated at a nano level, a composite in a state in which the conductive agent is incorporated in a bulk of the positive active material is formed. It is presumed that the formation of such a composite enhances the electron conductivity and improves performance.

The method of producing a nonaqueous electrolyte energy storage device according to one aspect of the present invention is a method of producing a nonaqueous electrolyte energy storage device including the method of producing a positive electrode.

According to the production method, it is possible to produce an energy storage device having a large discharge capacity at the initial stage and after the charge-discharge cycle and capable of being charged and discharged many times with a sufficient amount of electricity.

Hereinafter, the positive active material, the method of producing a positive active material, the positive electrode, the method of producing a positive electrode, the nonaqueous electrolyte energy storage device, and the method of producing a nonaqueous electrolyte energy storage device according to one embodiment of the present invention will be described in order.

### <Positive Active Material>

The positive active material according to one embodiment of the present invention contains an oxide including lithium, a transition metal element M, and a typical element A, and having an antifluorite crystal structure. The transition metal element M is cobalt, iron, copper, manganese, nickel, chromium, or a combination thereof. The typical element A is a group 13 element, a group 14 element, phosphorus, antimony, bismuth, tellurium, or a combination thereof. The molar ratio (A/(M+A)) of the content of the typical element A to the total content of the transition metal element M and the typical element Ain the oxide is more than 0.05 and 0.5 or less.

Since the positive active material contains the above oxide, the discharge capacity is large at the initial stage and after the charge-discharge cycle, and the positive active material can be charged and discharged many times with a sufficient amount of electricity.

The oxide includes lithium, the transition metal element M, and the typical element A and has an antifluorite crystal structure.

As the transition metal element M, Co is preferably contained, and Co is more preferable.

Examples of the group 13 element in the typical element A include B, Al, Ga, In and Tl. Examples of the group 14 element include C, Si, Ge, Sn, and Pb. As the typical element A, the group 13 element and the group 14 element are preferable. Furthermore, as the typical element A, a third period element (Al, Si, etc.) and a fourth period element (Ga and Ge) are preferable. Among these, as the typical element A, Al, Si, Ga and Ge are more preferable. By using these typical elements A, the discharge capacity at the initial stage and after the charge-discharge cycle becomes larger, and charge and discharge can be performed more times.

The molar ratio (A/(M+A)) of the content of the typical element A to the total content of the transition metal element M and the typical element A in the oxide is more than 0.05 and 0.5 or less, preferably 0.1 or more and 0.45 or less, more preferably 0.15 or more and 0.4 or less, and further preferably 0.2 or more and 0.35 or less. When the typical element A is, for example, Al or the like, the molar ratio (A/(M+A)) may be more preferably 0.25 or more or 0.3 or more. Furthermore, when the typical element A is Si, Ga, Ge or the like, the molar ratio (A/(M+A)) may be more preferably 0.3 or less or 0.25 or less. It is presumed that when the molar ratio (A/(M+A)) of the content of the typical element A is more than the above lower limit or the lower limit or more, the structural stability of the oxide is improved, so that the discharge capacity increases at the initial stage and after the charge-discharge cycle, and charge and discharge can be performed many times. On the other hand, it is presumed that when the molar ratio (A/(M+A)) of the content of the typical element A is the above upper limit or less, the generation of oxygen gas is suppressed or delayed, so that the discharge capacity increases at the initial stage and after the charge-discharge cycle, and charge and discharge can be performed many times. That is, when the molar ratio (A/(M+A)) of the content of the typical element A is in the above range, the discharge capacity increases at the initial stage and after the charge-discharge cycle, and charge and discharge can be performed many times.

A molar ratio ((M+A)/(Li+M+A)) of the total content of the transition metal element M and the typical element A to a total content of lithium Li, the transition metal element M, and the typical element A in the oxide is not particularly limited, and is, for example, preferably 0.05 or more and 0.3 or less, more preferably 0.1 or more and 0.2 or less, and further preferably 0.14 or more and 0.16 or less. The molar ratio ((M+A)/(Li+M+A)) serves as a guide for a solid solution content of the transition metal element M and the typical element A with respect to Li₂O, and the molar ratio ((M+A)/(Li+M+A)) is in the above range, so that the discharge capacity at the initial stage and after the charge-discharge cycle becomes larger, and charge and discharge can be performed more times.

The oxide may contain elements other than lithium, the transition metal element M, the typical element A, and oxygen. However, a molar ratio of the contents of the other elements to a total content of all the elements constituting the oxide is preferably 0.1 or less, more preferably 0.01 or less. The oxide may substantially include lithium, the transition metal element M, the typical element A, and oxygen. When the oxide substantially includes lithium, the transition metal element M, the typical element A, and oxygen, so that the discharge capacity at the initial stage and after the charge-discharge cycle becomes larger, and charge and discharge can be performed more times.

The oxygen content in the oxide is not particularly limited, and is usually determined from a composition ratio of lithium, the transition metal element M, the typical element A, and the like, and valences of these elements. However, the oxide may be an oxide with insufficient oxygen or excess oxygen.

The composition ratio of the oxide of the positive active material in the present specification refers to the composition ratio of the oxide that has not been charged and discharged, or the oxide that has been completely discharged by the following method. First, the nonaqueous electrolyte energy storage device is subjected to constant current charge with a current of 0.05 C until the voltage becomes an end-of-discharge voltage under normal usage, so that the energy storage device is brought to a fully charged state. After a 30-minute pause, the nonaqueous electrolyte energy storage device is subjected to constant current discharge with a current of 0.05 C to the lower limit voltage during normal usage. After the battery is disassembled to take out the positive electrode, a test battery using a metal lithium electrode as the counter electrode is assembled, constant current discharge is performed at a current value of 10 mA per 1 g of a positive composite until the positive potential reaches 2.0 V (vs. Li/Li+), the positive electrode is adjusted to the completely discharged state. The battery is disassembled again to take out the positive electrode. An oxide of the positive active material is collected from the taken-out positive electrode. Here, the term “during normal usage” means use of the nonaqueous electrolyte energy storage device while employing charge-discharge conditions recommended or specified in the nonaqueous electrolyte energy storage device, and when a charger for the nonaqueous electrolyte energy storage device is prepared, this term means use of the nonaqueous electrolyte energy storage device by applying the charger.

The composition formula of the oxide is preferably represented by the following formula (1).

[Li_{2-2z}M₂ₓA_{2y}]O (1)

In the above formula (1), M is Co, Fe, Cu, Mn, Ni, Cr or a combination thereof. A is a group 13 element, a group 14 element, P, Sb, Bi, Te or a combination thereof. x, y, and z satisfy the following formulas (a) to (d).

0<x<1 (a)

0<y<1 (b)

x+y≤z<1 (c)

0.05<y/(x+y)≤0.5 (d)

x in the above formula (1) relates to the content of the transition metal element M made into a solid solution in Li₂O and satisfies the above formula (a). x is preferably 0.01 or more and 0.5 or less, more preferably 0.03 or more and 0.2 or less, further preferably 0.05 or more and 0.15 or less, even preferably 0.06 or more and 0.12 or less, and particularly preferably 0.08 or more and 0.10 or less. When x is in the above range, the discharge capacity at the initial stage and after the charge-discharge cycle becomes larger, and charge and discharge can be performed more times.

y in the above formula (1) relates to the content of the typical element A made into a solid solution in Li₂O and satisfies the above formula (b). y is preferably 0.001 or more and 0.5 or less, more preferably 0.005 or more and 0.2 or less, further preferably 0.01 or more and 0.1 or less, and particularly preferably 0.02 or more and 0.05 or less. When y is in the above range, the discharge capacity at the initial stage and after the charge-discharge cycle becomes larger, and charge and discharge can be performed more times.

z in the above formula (1) relates to the content of Li and satisfies the above formula (c). If the valences of the transition metal element M and the typical element A are both +1 valence and x+y=z holds, a portion of the lithium site of Li₂O having an antifluorite structure is substituted with the transition metal element M and the typical element A. However, from the relation of the valences of the transition metal element M and the typical element A, the effect is not affected even if x+y<z. z is preferably 0.1 or more and 0.5 or less, more preferably 0.2 or more and 0.4 or less, and further preferably 0.26 or more and 0.32 or less.

y/(x+y) in the above formula (d) is a molar ratio (A/(M+A)) of a content (2y) of the typical element M relative to a total content (2x+2y) of the transition metal element M and the typical element A in the oxide. y/(x+y) is preferably 0.1 or more and 0.45 or less, more preferably 0.15 or more and 0.4 or less, and further preferably 0.2 or more and 0.35 or less. y/(x+y) may be more preferably 0.25 or more or 0.3 or more. Furthermore, y/(x+y) may be more preferably 0.3 or less or 0.25 or less. When y/(x+y) is in the above range, the discharge capacity at the initial stage and after the charge-discharge cycle becomes larger, and charge and discharge can be performed more times.

The lattice constant a of the oxide is preferably 0.4590 nm or more and 0.4630 nm or less, and more preferably 0.4597 nm or more and 0.4620 nm or less. The lattice constant a depends on the molar ratio (A/(M+A)) of the content of the typical element A to the total content of the transition metal element M and the typical element A, or the content of the typical element A, and as the molar ratio (A/(M+A)) of the content of the typical element A or the content of the typical element A increases, the lattice constant a tends to decrease. Therefore, when the lattice constant a of the oxide is in the above range, the molar ratio (A/(M+A)) of the content of the typical element A or the content of the typical element A is in a more suitable range, the discharge capacity at the initial stage and after the charge-discharge cycle becomes larger, and charge and discharge can be performed more times.

In the X-ray diffraction diagram using the CuKα ray of the oxide, the full width at half maximum of the diffraction peak near the diffraction angle 2θ=33° (for example, in the range of 30° or more and 35° or less) is preferably 0.3° or more, more preferably 0.5° or more, and further preferably 0.8° or more. When the full width at half maximum of the diffraction peak near the diffraction angle 2θ=33° is the lower limit or more, the discharge capacity at the initial stage and after the charge-discharge cycle becomes larger, and charge and discharge can be performed more times. The full width at half maximum of the diffraction peak near the diffraction angle 2θ=33° may be, for example, 5° or less, 3° or less, or 2° or less.

The positive active material may include components other than the oxide. However, the lower limit of the content of the oxide in the positive active material is preferably 70% by mass, more preferably 90% by mass, and further preferably 99% by mass. The upper limit of the content of this oxide may be 100% by mass. The positive active material may be substantially composed of only the oxide. As described above, since most of the positive active material is composed of the oxide, the discharge capacity at the initial stage and after the charge-discharge cycle becomes larger, and charge and discharge can be performed more times.

Examples of the components other than the oxide that may be contained in the positive active material include conventionally known positive active materials other than the oxide.

### <Method of Producing Positive Active Material>

The positive active material can be produced, for example, by the following method. That is, the method of producing a positive active material according to one embodiment of the present invention includes treating a material containing the transition metal element M and the typical element A by a mechanochemical method, in which the material contains (α) a lithium transition metal oxide including the transition metal element M and a compound including the typical element A, or

(β) contains a lithium transition metal oxide including the transition metal element M and the typical element A,

the transition metal element M is Co, Fe, Cu, Mn, Ni, Cr, or a combination thereof,

the typical element A is a group 13 element, a group 14 element, P, Sb, Bi, Te, or a combination thereof, and the molar ratio (A/(M+A)) of the content of the typical element A to the total content of the transition metal element M and the typical element Ain the material is more than 0.05 and 0.5 or less. The molar ratio (A/(M+A)) of the content of the typical element A is preferably 0.1 or more and 0.45 or less, more preferably 0.15 or more and 0.4 or less, and further preferably 0.2 or more and 0.35 or less. The molar ratio (A/(M+A)) may be more preferably 0.25 or more or 0.3 or more. Furthermore, the molar ratio (A/(M+A)) may be more preferably 0.3 or less or 0.25 or less.

According to the production method, a positive active material containing a oxide containing lithium, the transition metal element M, and the typical element A in a predetermined content ratio can be obtained by treating one or a plurality of materials containing a predetermined element by a mechanochemical method.

The mechanochemical method (also referred to as mechanochemical treatment or the like) refers to a synthesis method utilizing a mechanochemical reaction. The mechanochemical reaction refers to a chemical reaction such as a crystallization reaction, a solid solution reaction, or a phase transition reaction that utilizes high energy locally generated by mechanical energy such as friction and compression during a crushing process of a solid substance. In this production method, it is presumed that a reaction for forming a structure in which the transition metal element M and the typical element A are made into a solid solution in the crystal structure of Li₂O is caused by treatment using the mechanochemical method. Examples of apparatuses for performing the mechanochemical method include pulverizers/dispersers such as a ball mill, a bead mill, a vibration mill, a turbo mill, a mechano-fusion, and a disk mill. Among these, a ball mill is preferable. As the ball mill, those made of tungsten carbide (WC) and those made of zirconium oxide (ZrO₂) can be suitably used.

When treatment with the ball mill is performed, the number of revolutions of the balls during the treatment can be set to 100 rpm or more and 1,000 rpm or less, for example. The treatment time can be set to 0.1 hour or more and 10 hours or less, for example. This treatment can be performed in an inert gas atmosphere such as argon or an active gas atmosphere, but is preferably performed in the inert gas atmosphere.

The oxide contained in the positive active material obtained by the production method preferably has an antifluorite crystal structure. In the oxide obtained by treating with the mechanochemical method as in the production method, in the X-ray diffraction diagram using the CuKα ray, the full width at half maximum of the diffraction peak near the diffraction angle 2θ=33° tends to be as large as 0.3° or more.

The material subjected to the treatment using the mechanochemical method may be (α) a mixture containing a lithium transition metal oxide containing the transition metal element M and a compound containing the typical element A or (β) a lithium transition metal oxide containing the transition metal element M and the typical element A.

Examples of the lithium transition metal oxide containing the transition metal element M include Li₆CoO₄, Li₅CrO₄, Li₅FeO₄, Li₆NiO₄, Li₆CuO₄, and Li₆MnO₄. These lithium transition metal oxides containing the transition metal element M may have a crystal structure belonging to an antifluorite structure or may have another crystal structure. These lithium transition metal oxides can be obtained, for example, by mixing Li₂O and transition metal oxide including the transition metal element M such as CoO in a predetermined ratio and firing the mixture in a nitrogen atmosphere.

As the compound containing the typical element A, an oxide containing lithium and the typical element A is preferable. Examples of such compounds include Li₅AlO₄, Li₅GaO₄, Li₅InO₄, Li₄SiO₄, Li₄GeO₄, Li₄SnO₄, Li₃BO₃, Li₅SbO₅, Li₅BiO₅, and Li₆TeO₆. These compounds containing the typical element A may have a crystal structure belonging to an antifluorite structure or may have another crystal structure. Each of the above oxides can be obtained, for example, by mixing Li₂O and oxide including the typical element A such as Al₂O₃ in a predetermined ratio and firing the mixture in a nitrogen atmosphere.

When a mixture containing a lithium transition metal oxide containing the transition metal element M and a compound containing the typical element A is used as a material, the type and mixing ratio of the materials used are adjusted so that the molar ratio (A/(M+A)) of the content of the typical element A to the total content of the transition metal element M and the typical element A contained in the mixture is more than 0.05 and 0.5 or less.

Examples of the lithium transition metal oxide containing the transition metal element M and the typical element A include a lithium transition metal oxide represented by LiₐM_{b}A_{c}O₄ (0<a≤6, 0<b<1, 0<c<1, 0.05<c/(b+c)≤0.5) such as Li_{5.5}Co_{0.5}Al_{0.5}O₄ and Li_{5.8}Co_{0.8}Al_{0.2}O₄. The lithium transition metal oxide containing the transition metal element M and the typical element A can be obtained by a known method such as a firing method. The crystal structure of these lithium transition metal oxides is not particularly limited, for example, may be a crystal structure of each oxide used as the material, such as a crystal structure (crystal structure such as Li₆CoO₄) that can be assigned to the space group P42/nmc and a crystal structure (crystal structure such as Li₅AlO₄) that can be assigned to the space group Pmmn, and may include a plurality of crystal structures. The lithium transition metal oxide containing the transition metal element M and the typical element A may be an oxide in which a plurality of phases coexist. Examples of such an oxide include an oxide in which Al solid solution Li₆CoO₄ and Co solid solution LLi₅AlO₄ coexist. It is presumed that a reaction for forming a structure in which Co as the transition metal element and Al as the typical element are made into a solid solution in the crystal structure of Li₂O is caused by subjecting such an oxide to the treatment using the mechanochemical method.

### <Positive Electrode>

The positive electrode according to one embodiment of the present invention is a positive electrode for a nonaqueous electrolyte energy storage device having the positive active material described above. The positive electrode has a positive substrate and a positive active material layer disposed directly or via an intermediate layer on the positive substrate.

The positive substrate has conductivity. Having “conductivity” means having a volume resistivity of 10⁷ Ω·cm or less that is measured in accordance with JIS-H-0505 (1975), and the term “non-conductivity” means that the volume resistivity is more than 10⁷ Ω·cm. As the material of the positive substrate, a metal such as aluminum, titanium, tantalum, stainless steel, or an alloy thereof is used. Among these, aluminum and aluminum alloys are preferable from the viewpoint of the balance of electric potential resistance, high conductivity, and cost. Example of the form of formation of the positive substrate include a foil and a vapor deposition film, and a foil is preferred from the viewpoint of cost. That is, an aluminum foil is preferable as the positive substrate. Examples of aluminum and the aluminum alloy include A1085P and A3003P specified in JIS-H-4000 (2014).

The average thickness of the positive substrate is preferably 3 μm or more and 50 μm or less, more preferably 5 μm or more and 40 μm or less, still more preferably 8 μm or more and 30 μm or less, and particularly preferably 10 μm or more and 25 μm or less. When the average thickness of the positive substrate is within the above-described range, it is possible to enhance the energy density per volume of the energy storage device while increasing the strength of the positive substrate. The “average thickness” of the positive substrate and the negative substrate described below refers to a value obtained by dividing a cutout mass in cutout of a substrate having a predetermined area by a true density and a cutout area of the substrate.

The intermediate layer is a coating layer on the surface of the positive substrate, and contains conductive particles such as carbon particles to reduce contact resistance between the positive substrate and the positive active material layer. The configuration of the intermediate layer is not particularly limited but can be formed of, for example, a composition containing a resin binder and conductive particles.

The positive active material layer is formed of a so-called positive composite containing a positive active material. The positive composite forming the positive active material layer contains optional components such as a conductive agent, a binder, a thickener, a filler, or the like as necessary.

As the positive active material, the above-described positive active material according to one embodiment of the present invention is included. The positive active material may contain a known positive active material other than the positive active material according to one embodiment of the present invention. The content of the positive active material according to one embodiment of the present invention in the positive active material layer or the oxide (oxide including lithium, transition metal element M and typical element A and having an antifluorite crystal structure) contained in in the positive active material is preferably more than 10% by mass, more preferably 30% by mass or more, further preferably 50% by mass or more, and particularly preferably 65% by mass or more. As described above, by increasing the content ratio of the positive active material or the oxide in the positive active material layer, the discharge capacity at the initial stage and after the charge-discharge cycle becomes larger, and charge and discharge can be performed more times. On the other hand, the content of the positive active material according to one embodiment of the present invention in the positive active material layer or the oxide contained in the positive active material may be 99% by mass or less, may be 90% by mass or less, or may be 80% by mass or less.

The conductive agent is not particularly limited so long as it is a material having conductivity. Examples of such a conductive agent include carbonaceous materials; metals; and conductive ceramics. Examples of carbonaceous materials include graphite and carbon black. Examples of the type of the carbon black include furnace black, acetylene black, and ketjen black. Among these, carbonaceous materials are preferable from the viewpoint of conductivity and coatability. In particular, acetylene black and ketjen black are preferable. Examples of the shape of the conductive agent include a powder shape, a sheet shape, and a fibrous shape.

The positive active material and the conductive agent may be composited. Examples of the method of compositing include a method of mechanically milling a mixture containing the positive active material and the conductive agent, which will be described later.

The content of the conductive agent in the positive active material layer is preferably 1% by mass or more and 40% by mass or less, more preferably 3% by mass or more and 30% by mass or less. By setting the content of the conductive agent within the above range, the energy density of the energy storage device can be enhanced.

Examples of the binder include: thermoplastic resins such as fluororesin (polytetrafluoroethylene (PTFE), polyvinylidene fluoride (PVDF), etc.), polyethylene, polypropylene, and polyimide; elastomers such as ethylene-propylene-diene rubber (EPDM), sulfonated EPDM, styrene-butadiene rubber (SBR), and fluororubber; and polysaccharide polymers.

The content of the binder in the positive active material layer is preferably 1 mass % or more and 10 mass % or less, more preferably 3 mass % or more and 9 mass % or less. When the content of the binder is in the above range, the active material can be stably held.

Examples of the thickener include polysaccharide polymers such as carboxymethylcellulose (CMC) and methylcellulose. When the thickener has a functional group reactive with lithium, it is preferable to deactivate the functional group by methylation or the like in advance.

The filler is not particularly limited. Examples of the filler include polyolefins such as polypropylene and polyethylene, inorganic oxides such as silicon dioxide, aluminum oxide, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, barium sulfate and the like, nitrides such as aluminum nitride and silicon nitride, and substances derived from mineral resources, such as talc, montmorillonite, boehmite, zeolite, apatite, kaolin, mullite, spinel, olivine, sericite, bentonite and mica, and artificial products thereof.

The positive active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Nb, or W as a component other than the positive active material, the conductive agent, the binder, the thickener, and the filler.

### <Method of Producing Positive Electrode>

The positive electrode can be produced, for example, by the following method. That is, the method of producing a positive electrode according to one embodiment of the present invention includes preparing a positive electrode using the positive active material according to one embodiment of the present invention or the positive active material obtained by the method of producing a positive active material according to one embodiment of the present invention.

The positive electrode can be produced, for example, by applying a positive composite paste to a positive substrate directly or via an intermediate layer, followed by drying. The positive composite paste contains components constituting the positive composite such as the positive active material, and a conductive aid or a binder as an optional component. The positive composite paste may further contain a dispersion medium.

In the preparation of the positive electrode, when the positive active material and a conductive agent are mixed, it is preferable to mechanically mill a mixture containing the positive active material and the conductive agent As described above, when the positive active material containing the oxide containing the lithium, the transition metal element M, and the typical element A is used, the mechanical milling treatment is performed in the state of the mixture containing the positive active material and the conductive agent, whereby it is possible to highly reliably produce a positive electrode which can be a nonaqueous electrolyte energy storage device having sufficient discharge performance.

Here, the mechanical milling treatment refers to a treatment of applying mechanical energy such as impact, shear stress, or friction to perform pulverization, mixing, or compounding. Examples of apparatuses for performing the mechanical milling treatment include pulverizers/dispersers such as a ball mill, a bead mill, a vibration mill, a turbo mill, a mechano-fusion, and a disk mill. Among these, a ball mill is preferable. As the ball mill, those made of tungsten carbide (WC) and those made of zirconium oxide (ZrO₂) can be suitably used. The mechanical milling treatment here does not need to involve the mechanochemical reaction. It is presumed that such mechanical milling treatment composites the positive active material and the conductive agent, and improves the electron conductivity.

When treatment with the ball mill is performed, the number of revolutions of the balls during the treatment can be set to 100 rpm or more and 1,000 rpm or less, for example. The treatment time can be set to 0.1 hour or more and 10 hours or less, for example. This treatment can be performed in an inert gas atmosphere such as argon or an active gas atmosphere, but is preferably performed in the inert gas atmosphere.

### <Nonaqueous Electrolyte Energy Storage Device>

The energy storage device according to one embodiment of the present invention has a positive electrode, a negative electrode, and a nonaqueous electrolyte. Hereinafter, a nonaqueous electrolyte secondary battery (hereinafter, also simply referred to as a “secondary battery”) will be described as an example of the energy storage device. The positive electrode and the negative electrode usually form an electrode assembly alternately superposed by stacking or winding with a separator interposed therebetween. The electrode assembly is housed in a case, and the case is filled with the nonaqueous electrolyte. The nonaqueous electrolyte is interposed between the positive electrode and the negative electrode. As the case, a known metal case, a resin case or the like, which is usually used as a case of a secondary battery, can be used.

### (Positive Electrode)

The positive electrode provided in the secondary battery is the above-described positive electrode according to one embodiment of the present invention.

### (Negative Electrode)

The negative electrode has a negative substrate and a negative active material layer disposed directly or via an intermediate layer on the negative substrate. The intermediate layer may have the same configuration as the intermediate layer of the positive electrode.

Although the negative substrate may have the same configuration as that of the positive substrate, as the material, metals such as copper, nickel, stainless steel, and nickel-plated steel or alloys thereof are used, and copper or a copper alloy is preferable. That is, the negative substrate is preferably a copper foil. Examples of the copper foil include rolled copper foil, and electrolytic copper foil.

The average thickness of the negative substrate is preferably 2 μm or more and 35 μm or less, more preferably 3 μm or more and 30 μm or less, still more preferably 4 μm or more and 25 μm or less, and particularly preferably 5 μm or more and 20 μm or less. When the average thickness of the negative substrate is within the above-described range, it is possible to enhance the energy density per volume of a secondary battery while increasing the strength of the negative substrate.

The negative active material layer is generally formed of a so-called negative composite containing a negative active material. The negative composite forming the negative active material layer contains optional components such as a conductive agent, a binder, a thickener, a filler, or the like as necessary. As the optional components such as a conductive agent, a binder, a thickener, and a filler, the same components as those in the positive active material layer can be used. The negative electrode active material layer may be a layer substantially composed of only a negative active material such as metallic Li.

The negative active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Ta, Hf, Nb, or W as a component other than the negative active material, the conductive agent, the binder, the thickener, and the filler.

The negative active material can be appropriately selected from known negative active materials. For example, as the negative active material for a lithium ion secondary battery, a material capable of occluding and releasing lithium ions is usually used. Examples of the negative active material include metallic Li; metals or metalloids such as Si and Sn; metal oxides or metalloid oxides such as a Si oxide, a Ti oxide, and a Sn oxide; titanium-containing oxides such as Li₄Ti₅O₁₂, LiTiO₂, and TiNb₂O₇; a polyphosphoric acid compound; silicon carbide; and carbon materials such as graphite and non-graphitic carbon (easily graphitizable carbon or hardly graphitizable carbon). Among these materials, graphite and non-graphitic carbon are preferable. In the negative active material layer, one of these materials may be used singly, or two or more of these materials may be mixed and used.

The term “graphite” refers to a carbon material in which an average grid distance (d₀₀₂) of a (002) plane determined by an X-ray diffraction method before charge-discharge or in a discharged state is 0.33 nm or more and less than 0.34 nm. Examples of the graphite include natural graphite and artificial graphite. Artificial graphite is preferable from the viewpoint that a material having stable physical properties can be obtained.

The term “non-graphitic carbon” refers to a carbon material in which the average lattice distance (d₀₀₂) of the (002) plane determined by the X-ray diffraction method before charge-discharge or in the discharged state is 0.34 nm or more and 0.42 nm or less. Examples of the non-graphitic carbon include hardly graphitizable carbon and easily graphitizable carbon. Examples of the non-graphitic carbon include a resin-derived material, a petroleum pitch or a material derived from petroleum pitch, a petroleum coke or a material derived from petroleum coke, a plant-derived material, and an alcohol derived material.

Here, the “discharged state” of the carbon material refers to a state where an open circuit voltage is 0.7 V or more in a unipolar battery using a negative electrode, containing a carbon material as a negative active material, as a working electrode and using metallic Li as a counter electrode. Since the potential of the metallic Li counter electrode in an open circuit state is substantially equal to an oxidation/reduction potential of Li, the open circuit voltage in the unipolar battery is substantially equal to the potential of the negative electrode containing the carbon material with respect to the oxidation/reduction potential of Li. That is, the fact that the open circuit voltage in the unipolar battery is 0.7 V or more means that lithium ions that can be occluded and released in association with charge and discharge are sufficiently released from the carbon material that is the negative active material.

The “hardly graphitizable carbon” refers to a carbon material in which the d₀₀₂ is 0.36 nm or more and 0.42 nm or less.

The “easily graphitizable carbon” refers to a carbon material in which the d₀₀₂ is 0.34 nm or more and less than 0.36 nm.

When the form of the negative active material is a particle (powder), an average particle size of the negative active material can be, for example, 1 nm or more and 100 μm or less. When the negative active material is, for example, a carbon material, the average particle size thereof may be preferably 1 μm or more and 100 μm or less. When the negative active material is a metal, a metalloid, a metal oxide, a metalloid oxide, a titanium-containing oxide, a polyphosphoric acid compound or the like, the average particle size thereof may be preferably 1 nm or more and 1 μm or less. By setting the average particle size of the negative active material to be the above lower limit or more, the negative active material is easily produced or handled. By setting the average particle size of the negative active material to be the above upper limit or less, the electron conductivity of the positive active material layer is improved. A crusher and a classifier and the like are used to obtain a powder having a predetermined particle size. When the negative active material is metallic Li, the form may be foil-shaped or plate-shaped.

The content of the negative active material in the negative active material layer is preferably 60% by mass or more and 99% by mass or less, more preferably 90% by mass or more and 98% by mass or less, for example, when the negative active material layer is formed of a negative composite. When the content of the negative active material is in the above range, it is possible to achieve both high energy density and productivity of the negative active material layer. When the negative active material is metallic Li, the content of the negative active material in the negative active material layer may be 99% by mass or more, and may be 100% by mass.

### (Separator)

The separator can be appropriately selected from known separators. As the separator, for example, a separator composed of only a substrate layer, a separator in which a heat resistant layer containing heat resistant particles and a binder is formed on one surface or both surfaces of the substrate layer, or the like can be used. Examples of a material of the substrate layer of the separator include a woven fabric, a nonwoven fabric, and a porous resin film. Among these materials, a porous resin film is preferable from the viewpoint of strength, and a nonwoven fabric is preferable from the viewpoint of liquid retention property of the nonaqueous electrolyte. As the material of the substrate layer of the separator, a polyolefin such as polyethylene or polypropylene is preferable from the viewpoint of a shutdown function, and polyimide, aramid or the like is preferable from the viewpoint of resistance to oxidation and decomposition. As the substrate layer of the separator, a material obtained by combining these resins may be used.

The heat resistant particles contained in the heat resistant layer preferably have a mass loss of 5% or less at 500° C. in the atmosphere, and more preferably have a mass loss of 5% or less at 800° C. in the atmosphere. Inorganic compounds can be mentioned as materials whose mass loss is a predetermined value or less. Examples of the inorganic compound include oxides such as iron oxide, silicon oxide, aluminum oxide, titanium dioxide, barium titanate, zirconium oxide, calcium oxide, strontium oxide, barium oxide, magnesium oxide and aluminosilicate; hydroxides such as magnesium hydroxide, calcium hydroxide and aluminum hydroxide; nitrides such as aluminum nitride and silicon nitride; carbonates such as calcium carbonate; sulfates such as barium sulfate; hardly soluble ionic crystals of calcium fluoride, barium fluoride, and the like; covalently bonded crystals such as silicon and diamond; and substances derived from mineral resources, such as talc, montmorillonite, boehmite, zeolite, apatite, kaolin, mullite, spinel, olivine, sericite, bentonite and mica, and artificial products thereof. As the inorganic compound, a simple substance or a complex of these substances may be used alone, or two or more kinds thereof may be mixed and used. Among these inorganic compounds, silicon oxide, aluminum oxide, or aluminosilicate is preferable from the viewpoint of safety of the energy storage device.

A porosity of the separator is preferably 80 vol % or less from the viewpoint of strength, and is preferably 20 vol % or more from the viewpoint of discharge performance. Here, the “porosity” is a volume-based value, and means a value measured with a mercury porosimeter.

As the separator, a polymer gel composed of a polymer and a nonaqueous electrolyte may be used. Examples of the polymer include polyacrylonitrile, polyethylene oxide, polypropylene oxide, polymethyl methacrylate, polyvinyl acetate, polyvinylpyrrolidone, and polyvinylidene fluoride. The use of polymer gel has the effect of suppressing liquid leakage. As the separator, a polymer gel may be used in combination with a porous resin film, a nonwoven fabric, or the like as described above.

### (Nonaqueous Electrolyte)

The nonaqueous electrolyte can be appropriately selected from known nonaqueous electrolytes. As the nonaqueous electrolyte, a nonaqueous electrolyte solution may be used. The nonaqueous electrolyte solution contains a nonaqueous solvent and an electrolyte salt dissolved in the nonaqueous solvent.

The nonaqueous solvent can be appropriately selected from known nonaqueous solvents. Examples of the nonaqueous solvent include cyclic carbonates, chain carbonates, carboxylic acid esters, phosphoric acid esters, sulfonic acid esters, ethers, amides, and nitriles. As the nonaqueous solvent, those in which some hydrogen atoms contained in these compounds are substituted with halogen may be used.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among these, EC is preferable.

Examples of the chain carbonate include diethyl carbonate (DEC), dimethyl carbonate (DMC), ethyl methyl carbonate (EMC), diphenyl carbonate, trifluoroethyl methyl carbonate, and bis(trifluoroethyl)carbonate. Among these, DMC and EMC are preferable.

As the nonaqueous solvent, it is preferable to use at least one of the cyclic carbonate and the chain carbonate, and it is more preferable to use the cyclic carbonate and the chain carbonate in combination. By using the cyclic carbonate, dissociation of the electrolyte salt can be promoted to improve ionic conductivity of the nonaqueous electrolyte solution. By using the chain carbonate, viscosity of the nonaqueous electrolyte solution can be suppressed to be low. When the cyclic carbonate and the chain carbonate are used in combination, a volume ratio of the cyclic carbonate to the chain carbonate (cyclic carbonate:chain carbonate) is preferably in a range from 5:95 to 50:50, for example.

The electrolyte salt can be appropriately selected from known electrolyte salts. Examples of the electrolyte salt include a lithium salt, a sodium salt, a potassium salt, a magnesium salt, and an onium salt. Among these, a lithium salt is preferable.

Examples of the lithium salt include inorganic lithium salts such as LiPF₆, LiPO₂F₂, LiBF₄, LiClO₄, and LiN(SO₂F)₂, and lithium salts having a halogenated hydrocarbon group, such as LiSO₃CF₃, LiN(SO₂CF₃)₂, LiN(SO₂C₂F₅)₂, LiN(SO₂CF₃)(SO₂C₄F₉), LiC(SO₂CF₃)₃ and LiC(SO₂C₂F₅)₃.

Among these, an inorganic lithium salt is preferable, and LiPF₆ is more preferable.

The content of the electrolyte salt in the nonaqueous electrolyte solution is preferably 0.1 mol/dm³ or more and 2.5 mol/dm³ or less, more preferably 0.3 mol/dm³ or more and 2.0 mol/dm³ or less, further preferably 0.5 mol/dm³ or more and 1.7 mol/dm³ or less, and particularly preferably 0.7 mol/dm³ or more and 1.5 mol/dm³ or less. When the content of the electrolyte salt is within the above range, the ionic conductivity of the nonaqueous electrolyte solution can be increased.

The nonaqueous electrolyte solution may contain an additive. Examples of the additive include aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-dlifluoroanisole; succinic anhydride, glutaric anhydride, maleic anhydride, citraconic anhydride, glutaconic anhydride, itaconic anhydride, and cyclohexanedicarboxylic anhydride; ethylene sulfite, propylene sulfite, dimethyl sulfite, dimethyl sulfate, ethylene sulfate, sulfolane, dimethyl sulfone, diethyl sulfone, dimethyl sulfoxide, diethyl sulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, perfluorooctane, tristrimethylsilyl borate, tristrimethylsilyl phosphate, and tetrakistrimethylsilyl titanate. These additives may be used singly, or two or more may be mixed and used.

The content of the additive contained in the nonaqueous electrolyte solution is preferably 0.01% by mass or more and 10% by mass or less, more preferably 0.1% by mass or more and 7% by mass or less, further preferably 0.2% by mass or more and 5% by mass or less, and particularly preferably 0.3% by mass or more and 3% by mass or less, with respect to a total mass of the nonaqueous electrolyte solution. When the content of the additive is within the above range, it is possible to improve capacity retention performance or charge-discharge cycle performance after high-temperature storage, and to further improve safety.

As the nonaqueous electrolyte, a solid electrolyte may be used, or a nonaqueous electrolyte solution and a solid electrolyte may be used in combination.

The solid electrolyte can be selected from any material having ionic conductivity such as lithium, sodium and calcium and being solid at room temperature (for example, 15° C. to 25° C.). Examples of the solid electrolyte include sulfide solid electrolytes, oxide solid electrolytes, oxynitride solid electrolytes, and polymer solid electrolytes.

Examples of the lithium ion secondary battery include Li₂S—P₂S₅, LiI—Li₂S—P₂S₅, and Li₁₀Ge—P₂S₁₂ as the sulfide solid electrolyte.

The shape of the energy storage device of the present embodiment is not particularly limited, and examples thereof include cylindrical batteries, laminated film batteries, prismatic batteries, flat batteries, coin batteries and button batteries.

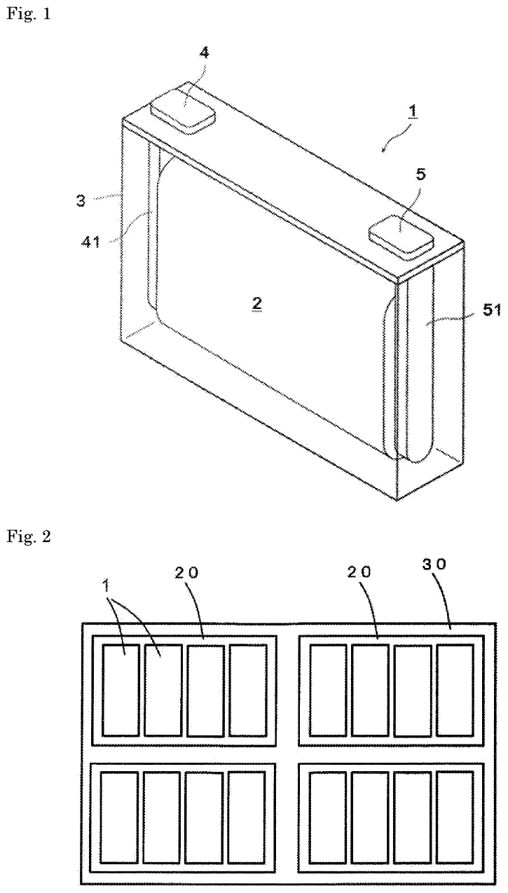

FIG. 1 shows an energy storage device 1 (nonaqueous electrolyte energy storage device) as an example of a prismatic battery. FIG. 1 is a view showing an inside of a case in a perspective manner. An electrode assembly 2 having a positive electrode and a negative electrode which are wound with a separator interposed therebetween is housed in a prismatic case 3. The positive electrode is electrically connected to a positive electrode terminal 4 through a positive electrode lead 41. The negative electrode is electrically connected to a negative electrode terminal 5 via a negative electrode lead 51.

### <Configuration of Nonaqueous Electrolyte Energy Storage Apparatus>

The energy storage device of the present embodiment can be mounted as an energy storage unit (battery module) configured by assembling a plurality of energy storage devices 1 on a power source for automobiles such as electric vehicles (EV), hybrid vehicles (HEV), and plug-in hybrid vehicles (PHEV), a power source for electronic devices such as personal computers and communication terminals, or a power source for power storage, or the like. In this case, the technique according to one embodiment of the present invention may be applied to at least one energy storage device included in the energy storage unit.

FIG. 2 illustrates an example of an energy storage apparatus 30 formed by assembling energy storage units 20 in each of which two or more electrically connected energy storage devices 1 are assembled. The energy storage apparatus 30 may include a busbar (not illustrated) for electrically connecting two or more energy storage devices 1, a busbar (not illustrated) for electrically connecting two or more energy storage units 20, and the like. The energy storage unit 20 or the energy storage apparatus 30 may include a state monitor (not illustrated) for monitoring the state of one or more energy storage devices.

### <Method of Producing Nonaqueous Electrolyte Energy Storage Device>

The energy storage device can be manufactured by using the positive active material. The method of producing a nonaqueous electrolyte energy storage device according to one embodiment of the present invention includes the method of producing a positive electrode according to one embodiment of the present invention.

The method of producing the energy storage device includes, for example, preparing the positive electrode described above, preparing a negative electrode, preparing a nonaqueous electrolyte, forming an electrode assembly in which the positive electrode and the negative electrode are alternately superposed by stacking or winding the positive electrode and the negative electrode with a separator interposed between the electrodes, housing the positive electrode and the negative electrode (electrode assembly) in a case, and injecting the nonaqueous electrolyte into the case. The energy storage device can be obtained by sealing an injection port after the injection.

### Other Embodiments

The present invention is not limited to the above embodiments, and various modifications may be made without departing from the gist of the present invention. For example, a configuration according to one embodiment can additionally be provided with a configuration according to another embodiment, or a configuration according to one embodiment can partially be replaced with a configuration according to another embodiment or a well-known technique. Furthermore, a configuration according to one embodiment can be removed partially. In addition, a well-known technique can be added to a configuration according to one embodiment.

In the above embodiment, although the case where the energy storage device is used as a nonaqueous electrolyte secondary battery (for example, lithium ion secondary battery) that can be charged and discharged has been described, the type, shape, size, capacity, and the like of the energy storage device are arbitrary. The nonaqueous electrolyte energy storage device of the present invention can also be applied to capacitors such as various nonaqueous electrolyte secondary batteries, electric double layer capacitors, and lithium ion capacitors. The positive active material and the positive electrode of the present invention can also be used for the positive active material and the positive electrode other than the nonaqueous electrolyte energy storage device.

### EXAMPLES

Hereinafter, the present invention will be described more specifically by way of examples, but the present invention is not limited to the following examples.

### [Synthesis Example 1] Synthesis of Li₆CoO₄

Li₂O and CoO were mixed at a molar ratio of 3:1 and then fired at 900° C. for 20 hours under a nitrogen atmosphere to synthesize Li₆CoO₄.

### [Synthesis Example 2] Synthesis of Li₅AlO₄

Li₂O and Al₂O₃ were mixed at a molar ratio of 5:1 and then fired at 900° C. for 20 hours in an atmospheric atmosphere to obtain Li₅AlO₄.

### [Synthesis Example 3] Synthesis of Li₅GaO₄

Li₂O and Ga₂O₃ were mixed at a molar ratio of 5:1 and then fired at 900° C. for 20 hours in a nitrogen atmosphere to obtain Li₅GaO₄.

### [Synthesis Example 4] Synthesis of Li₄SiO₄

Li₂O and SiO₂ were mixed at a molar ratio of 2:1 and then fired at 900° C. for 12 hours in an atmospheric atmosphere to obtain Li₄SiO₄.

### [Synthesis Example 5] Synthesis of Li₄GeO₄

Li₂O and GeO₂ were mixed at a molar ratio of 2:1 and then fired at 900° C. for 20 hours in a nitrogen atmosphere to obtain Li₄GeO₄.

### [Reference Synthesis Example 1] Synthesis of Li₅₈Co_{0.8}Al₀₂O₄

Li₂O, CoO, and Al₂O₃ were mixed at a molar ratio of 29:8:1 and then fired at 900° C. for 20 hours under a nitrogen atmosphere to obtain Li_{5.8}Co_{0.8}Al_{0.2}O₄.

### [Reference Synthesis Example 2] Synthesis of Li_{5.5}Co_{0.5}Al_{0.5}O₄

Li₂O, CoO, and Al₂O₃ were mixed at a molar ratio of 11:2:1 and then fired at 900° C. for 20 hours under a nitrogen atmosphere to obtain Li_{5.5}Co_{0.5}Al_{0.5}O₄.

### [Reference Synthesis Example 3] Synthesis of Li_{5.2}Co_{0.2}Al_{0.8}O₄

Li₂O, CoO, and Al₂O₃ were mixed at a molar ratio of 13:1:2 and then fired at 900° C. for 20 hours under a nitrogen atmosphere to obtain Li_{5.2}Co_{0.2}Al_{0.8}O₄.

### (X-Ray Diffraction Measurement of Lithium Cobalt Oxide, Lithium Aluminum Oxide, and Lithium Cobalt Aluminum Oxide)

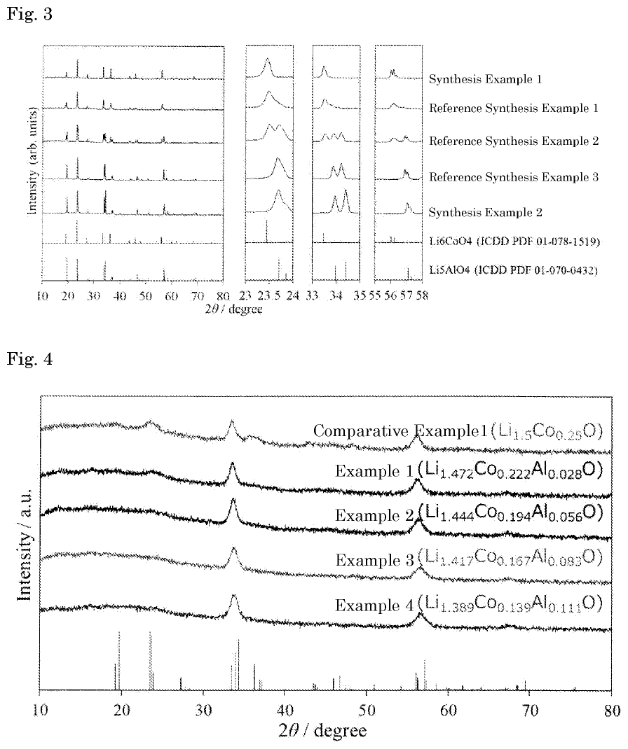

For Li₆CoO₄ (Synthesis Example 1), Li₅AlO₄ (Synthesis Example 2), Li_{5.8}Co_{0.8}Al_{0.2}O₄ (Reference Synthesis Example 1), Li_{5.5}Co_{0.5}Al_{0.5}O₄ (Reference Synthesis Example 2) and Li_{5.2}Co_{0.2}Al_{0.8}O₄ (Reference Synthesis Example 3) obtained in the above synthesis example, X-ray diffraction measurement was performed. A powder sample was filled in an argon atmosphere using an airtight sample holder for X-ray diffraction measurement. The X-ray diffractometer, measurement conditions, and data processing method used were as described above. Each X-ray diffraction pattern is shown in FIG. 3.

From the X-ray diffraction pattern of Synthesis Example 1 (Li₆CoO₄), a single phase that can be attributed to a space group P42/nmc can be confirmed, and it can be confirmed that the target Li₆CoO₄ has been synthesized.

From the X-ray diffraction pattern of Synthesis Example 2 (Li₅AlO₄), a single phase that can be attributed to the space group Pmmn can be confirmed, and it can be confirmed that the target Li₅AlO₄ has been synthesized.

### Example 1

The obtained Li₆CoO₄ and Li₅AlO₄ were mixed at a molar ratio of 8:1, and then treated in a tungsten carbide (WC) ball mill under an argon atmosphere at a rotation speed of 400 rpm for 2 hours. A positive active material (Li_{1.472}Co_{0.222}Al_{0.028}O) of Example 1 was obtained by treatment using the mechanochemical method as described above.

### Examples 2 to 7, Comparative Example 1

Each positive active material of Examples 2 to 7 and Comparative Example 1 was obtained similarly to Example 1, except that the materials used were as shown in Table 1. Table 1 also shows the composition formula of the obtained positive active material (oxide).

TABLE 1

| | | Positive active material (oxide) | | | | | | | | |
|---|---|---|---|---|---|---|---|---|---|---|
| | | | | | | | | | Full width at half | Lattice |
| | | | | | | | | Molar ratio | maximum of 33° | constant a |
| | Material | [Li_{2-2z}M₂ₓA_{2y}]O | M | A | x | y | z | A/(M + A) | diffraction peak (°) | (nm) |
| Comparative | Li₆CoO₄ | Li_{1.5}Co_{0.25}O | Co | — | 0.125 | 0 | 0.25 | 0 | 0.89 | 0.4636 |
| Example 1 | | | | | | | | | | |
| Example 1 | 8Li₆CoO₄ + Li₅AlO₄ | Li_{1.472}Co_{0.222} | Co | Al | 0.111 | 0.014 | 0.264 | 0.11 | 0.85 | 0.4626 |
| | | Al_{0.028}O | | | | | | | | |
| Example 2 | 7Li₆CoO₄ + 2Li₅AlO₄ | Li_{1.444}Co_{0.194} | Co | Al | 0.097 | 0.028 | 0.278 | 0.22 | 0.93 | 0.4614 |
| | | Al_{0.056}O | | | | | | | | |
| Example 3 | 6Li₆CoO₄ + 3Li₅AlO₄ | Li_{1.417}Co_{0.167} | Co | Al | 0.083 | 0.042 | 0.292 | 0.33 | 1.05 | 0.4599 |
| | | Al_{0.083}O | | | | | | | | |
| Example 4 | 5Li₆CoO₄ + 4Li₅AlO₄ | Li_{1.389}Co_{0.139} | Co | Al | 0.069 | 0.056 | 0.306 | 0.44 | 1.10 | 0.4595 |
| | | Al_{0.111}O | | | | | | | | |
| Example 5 | 7Li₆CoO₄ + 2Li₅GaO₄ | Li_{1.444}Co_{0.194} | Co | Ga | 0.097 | 0.028 | 0.278 | 0.22 | 0.91 | 0.4618 |
| | | Ga_{0.056}O | | | | | | | | |
| Example 6 | 7Li₆CoO₄ + 2Li₄SiO₄ | Li_{1.389}Co_{0.194} | Co | Si | 0.097 | 0.028 | 0.306 | 0.22 | 1.20 | 0.4611 |
| | | Si_{0.056}O | | | | | | | | |
| Example 7 | 7Li₆CoO₄ + 2Li₄GeO₄ | Li_{1.389}Co_{0.194} | Co | Ge | 0.097 | 0.028 | 0.306 | 0.22 | 1.16 | 0.4614 |
| | | Ge_{0.056}O | | | | | | | | |

### (X-Ray Diffraction Measurement of Positive Active Material)

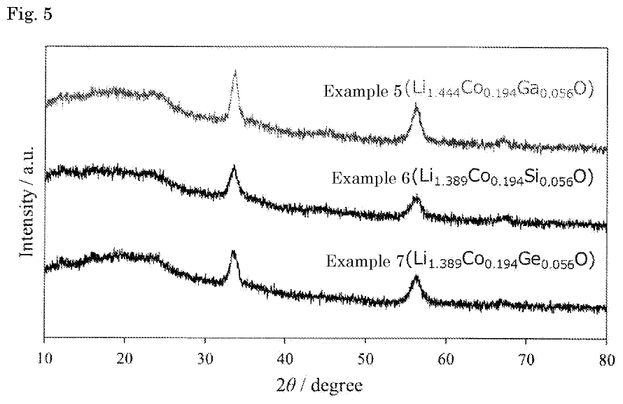

X-ray diffraction measurement was performed on the positive active materials obtained in the above Examples and Comparative Examples by the same method as described above. It could be confirmed that all the positive active materials had the same crystal structure (antifluorite crystal structure) as Li₂O as a main phase. FIG. 4 shows an X-ray diffraction pattern of each positive active material of Examples 1 to 4 and Comparative Example 1, and FIG. 5 shows an X-ray diffraction pattern of each positive active material of Examples 5 to 7. Table 1 shows the full width at half maximum of the diffraction peak near the diffraction angle 2θ=33° in the positive active materials of Examples 1 to 7 and Comparative Example 1 obtained from the X-ray diffraction measurement, and the lattice constant a.

### (Characteristics of X-Ray Diffraction Pattern)

As can be seen from FIGS. 4 and 5, in the X-ray diffraction pattern of the positive active material according to each Example, a characteristic diffraction peak is observed near the diffraction angle 2θ=33°. As can be seen in comparison of FIG. 3 which is an X-ray diffraction pattern of the oxide obtained by a solid phase reaction method to FIGS. 4 and 5 which are X-ray diffraction patterns of the positive active material (oxide) obtained by the treatment by the mechanochemical method, the full width at half maximum of the diffraction peak near 33° is significantly increased by the treatment by the mechanochemical method. In the materials (oxides of Synthesis Examples 1 and 2 and Reference Synthesis Examples 1 to 3) obtained by a solid phase reaction method that have not been treated by the mechanochemical method, the full width at half maximum of the diffraction peak near 33° was less than 0.3°. For example, the value was 0.10° in Synthesis Example 1, 0.16° in Synthesis Example 2, and 0.15° in Reference Synthesis Example 2. On the other hand, in the positive active material (oxides of Examples 1 to 7 and Comparative Example 1) obtained via the mechanochemical treatment, as shown in Table 1, the full width at half maximum of the diffraction peak near 33° was 0.3° or more.

It can be confirmed from FIG. 4 that when the molar ratio (A/(M+A)) of the content of the typical element A increases, the diffraction peak near 25° disappears, and the diffraction peak near 33° shifts to a direction in which the diffraction angle is large. Corresponding to such a change in the X-ray diffraction pattern, as shown in Table 1, when the molar ratio (A/(M+A)) of the content of the typical element A increases, the lattice constant a decreases. It is presumed that these changes are due to the increase in the content of the typical element A.

### (Preparation of Positive Electrode)

Under an argon atmosphere, 1.125 g of the positive active material obtained in each Example and Comparative Example and 0.300 g of Ketjen Black were mixed and placed in a WC pot having an inner volume of 80 mL and containing 250 g of WC balls having a diameter of 5 mm, and the pot was closed with a lid. The pot was set in a planetary ball mill (“pulverisette 5” from FRITSCH) and dry-pulverized at a revolution speed of 200 rpm for 30 minutes to prepare a mixed powder of the positive active material and Ketjen black.

95 parts by mass of the mixed powder and 5 parts by mass of polytetrafluoroethylene powder were kneaded in an agate mortar and molded into a sheet shape. The sheet was punched into a disk shape with a diameter of 12 mmϕ to prepare a positive electrode sheet with a mass of about 0.01 g. The positive electrode sheet was pressure-bonded to a current collector (diameter 19 mmϕ) made of aluminum mesh to obtain a positive electrode.

### (Production of Nonaqueous Electrolyte Energy Storage Device (Evaluation Cell))

LiPF₆ was dissolved at a concentration of 1 mol/dm³ in a nonaqueous solvent in which EC, DMC, and EMC were mixed at a volume ratio of 30:35:35 to prepare a nonaqueous electrolyte. A lithium metal having a thickness of 100 μm and a diameter of 20 mmϕ was placed on a negative substrate made of copper foil to form a negative electrode. A Tomcell (manufactured by Nippon Tomcell Co., Ltd.) was used as an evaluation cell (energy storage device). A polypropylene microporous membrane was used as the separator. The negative electrode, the separator, and the positive electrode were stacked inside a packing disposed on a stainless steel lower lid, 0.3 mL of the nonaqueous electrolyte (electrolyte solution) was injected, one spacer and one V-shaped plate spring were used, and a stainless steel top lid was tightened with a nut and fixed. In this way, a nonaqueous electrolyte energy storage device (evaluation cell) was prepared. All operations from the preparation of the positive electrode to the preparation of the evaluation cell were performed in an argon atmosphere.

### (Charge-Discharge Test)

With respect to the evaluation cells obtained using the respective positive active materials of Examples 1 to 7 and Comparative Examples 1, a charge-discharge test was performed in a 25° C. temperature environment in a glove box under an argon atmosphere. A current density was set to 50 mA/g per mass of the positive active material contained in the positive electrode, and constant current (CC) charge-discharge was performed. The charge-discharge test started with charging, and the charge was terminated when the electric amount reached 400 mAh/g which was the upper limit or the potential reached 4.5 V which was the upper limit. The discharge was terminated when the electric amount reached 400 mAh/g which was the upper limit or the voltage reached 1.5 V which was the upper limit. This charge-discharge cycle was repeated for 8 cycles. For those whose charge capacity maintained 400 mAh/g during 8 cycles, the charge-discharge cycle was further repeated until the charge capacity fell below 400 mAh/g or reached 30 cycles. Table 2 shows the discharge capacity in the first cycle, the discharge capacity in the eighth cycle, and the number of charge-discharge cycles in which charge at 400 mAh/g was maintained.

For each of the positive active materials of Examples 3, 5, 6 and 7, the evaluation cell similar to the above was prepared separately, and a test was performed in which the upper limit electric amount for charge and discharge was changed to 450 mAh/g in an environment of 25° C. That is, the charge-discharge test was performed similarly to the above except that charge was terminated when electric amount reached 450 mAh/g which was the upper limit or voltage reached 4.5 V which was the upper limit, and for those whose charge capacity maintained 450 mAh/g during 8 cycles, the charge-discharge cycle was further repeated until the charge capacity fell below 450 mAh/g or reached 30 cycles. Table 3 shows the discharge capacity in the first cycle, the discharge capacity in the eighth cycle, and the number of charge-discharge cycles in which charge at 450 mAh/g was maintained.

TABLE 2

| | | | Charge-discharge test | | |
|---|---|---|---|---|---|
| | Positive active material (oxide) | | Discharge | Discharge | Number of |
| | | Molar | capacity in | capacity in | cycles in charge |
| | | ratio | first cycle | eighth cycle | at 400 mA/g |
| | [Li₂₋₂ₓM₂ₓA_{2y}]O | A/(M + A) | (mAh/g) | (mAh/g) | (times) |
| Comparative | Li_{1.5}Co_{0.25}O | 0 | 323 | 60 | 4 |
| Example 1 | | | | | |
| Example 1 | Li_{1.472}Co_{0.222}Al_{0.028}O | 0.11 | 399 | 215 | 9 |
| Example 2 | Li_{1.444}Co_{0.194}Al_{0.056}O | 0.22 | 400 | 392 | 15 |
| Example 3 | Li_{1.417}Co_{0.167}Al_{0.083}O | 0.33 | 399 | 392 | 30 |
| Example 4 | Li_{1.389}Co_{0.139}Al_{0.111}O | 0.44 | 371 | 163 | 7 |
| Example 5 | Li_{1.444}Co_{0.194}Ga_{0.056}O | 0.22 | 400 | 392 | 17 |
| Example 6 | Li_{1.389}Co_{0.194}Si_{0.056}O | 0.22 | 400 | 394 | 30 |
| Example 7 | Li_{1.389}Co_{0.194}Ge_{0.056}O | 0.22 | 400 | 394 | 30 |

TABLE 3

| | | | Charge-discharge test | | |
|---|---|---|---|---|---|
| | Positive active material (oxide) | | Discharge | Discharge | Number of |
| | | Molar | capacity in | capacity in | cycles in charge |
| | | ratio | first cycle | eighth cycle | at 450 mA/g |
| | [Li₂₋₂ₓM₂ₓA_{2y}]O | A/(M + A) | (mAh/g) | (mAh/g) | (times) |
| Example 3 | Li_{1.417}Co_{0.167}Al_{0.083}O | 0.33 | 419 | 435 | 15 |
| Example 5 | Li_{1.444}Co_{0.194}Ga_{0.056}O | 0.22 | 447 | 427 | 12 |
| Example 6 | Li_{1.389}Co_{0.194}Si_{0.056}O | 0.22 | 450 | 442 | 29 |
| Example 7 | Li_{1.389}Co_{0.194}Ge_{0.056}O | 0.22 | 449 | 442 | 26 |

As shown in Table 2, in Examples 1 to 7 in which the molar ratio (A/(M+A)) of the content of the typical element A to the total content of the transition metal element M and the typical element A was more than 0.05 and 0.5 or less, the discharge capacity in the first cycle exceeded 370 mAh/g, and the discharge capacity in the eighth cycle also exceeded 100 mAh/g. Charge at 400 mAh/g could be performed over 7 or more cycles. That is, it could confirmed that in the positive active materials of Examples 1 to 7, the discharge capacity is large at the initial stage and after the charge-discharge cycle, and the positive active materials could be charged and discharged many times with a sufficient amount of electricity. In particular, from the comparison of Examples 1 to 4, it could confirmed that the above performance was further enhanced by optimizing the molar ratio (A/(M+A)) of the content of the typical element A.

As shown in Table 3, it could be confirmed that each of the positive active materials of Examples 3, 5, 6 and 7 had good charge-discharge cycle performance even if the charge-discharge cycle was performed with a larger charge capacity.

### INDUSTRIAL APPLICABILITY

The present invention can be applied to a nonaqueous electrolyte energy storage device used as a power source for electronic devices such as personal computers and communication terminals, automobiles, and the like, a positive electrode, a positive active material, and the like provided in the nonaqueous electrolyte energy storage device.

### DESCRIPTION OF REFERENCE SIGNS

1: nonaqueous electrolyte energy storage device
2: electrode assembly
3: case
4: positive electrode terminal
41: positive electrode lead
5: negative electrode terminal
51: negative electrode lead
20: energy storage unit
30: energy storage apparatus

1. A positive active material comprising an oxide having an antifluorite crystal structure, the oxide containing lithium, a transition metal element and a typical element,
wherein the transition metal element is cobalt, iron, copper, manganese, nickel, chromium, or a combination thereof,
the typical element is a group 13 element, a group 14 element, phosphorus, antimony, bismuth, tellurium or a combination thereof, and
a molar ratio of a content of the typical element to a total content of the transition metal element and the typical element in the oxide is more than 0.05 and 0.5 or less.

2. The positive active material according to claim 1, wherein a lattice constant a of the oxide is 0.4590 nm or more and 0.4630 nm or less.

3. The positive active material according to claim 1, wherein in an X-ray diffraction pattern of the oxide using a CuKα ray, a full width at half maximum of a diffraction peak near a diffraction angle 2θ=33° is 0.3° or more.

4. A positive electrode comprising the positive active material according to claim 1.

5. The positive electrode according to claim 4, further comprising a positive active material layer containing the positive active material,
wherein a content of the oxide in the positive active material layer is more than 10% by mass.

6. A nonaqueous electrolyte energy storage device comprising the positive electrode according to claim 4.

7. A method of producing a positive active material, comprising treating a material containing a transition metal element and a typical element by a mechanochemical method,
wherein the material contains a lithium transition metal oxide including the transition metal element and a compound including the typical element, or contains a lithium transition metal oxide including the transition metal element and the typical element,
the transition metal element is cobalt, iron, copper, manganese, nickel, chromium, or a combination thereof,
the typical element is a group 13 element, a group 14 element, phosphorus, antimony, bismuth, tellurium or a combination thereof, and
a molar ratio of a content of the typical element to a total content of the transition metal element and the typical element in the material is more than 0.05 and 0.5 or less.

8. A method of producing a positive electrode, comprising preparing the positive electrode using the positive active material according to claim 1.

9. The method of producing a positive electrode according to claim 8, wherein the preparing the positive electrode comprises mechanically milling a mixture containing the positive active material.

10. A method of producing a nonaqueous electrolyte energy storage device comprising the method of producing a positive electrode according to claim 8.
